(19) United States
(12) Patent Application Publication
(10) Pub. No.: US 2011/0271671 A1
(43) Pub. Date: Nov. 10, 2011

(54) OPTIMIZED GEOMETRY TURBOCOMPRESSOR

(75) Inventors: Vincent Parvaud, Reuil Malmaison (FR); Stefan Sundermann, Saint Germain en Laye (FR)

(73) Assignee: ROBERT BOSCH GMBH, Stuttgart (DE)

(21) Appl. No.: 13/127,106

(22) PCT Filed: Oct. 14, 2009
(86) PCT No.: PCT/EP09/63391

§ 371 Date: Jul. 21, 2011

(30) Foreign Application Priority Data
Oct. 30, 2008 (FR) 0806085

(51) Int. Cl. F02B 33/44

(52) U.S. Cl. 60/598

(57) ABSTRACT

The present invention relates mainly to an optimized turbocompressor for engines mounted transversely, notably for in-line four-cylinder engines mounted transversely.

The main subject of the invention is a turbocompressor (1′) comprising a turbine (3′) and coupling means (5′) and a compressor (7′), characterized in that, when looking in the direction (X-X′) from the compressor (7′) toward the turbine (3′) the rotating parts of the compressor rotate in the positive trigonometric direction.

Another subject of the invention is a turbocompressor (1′) comprising a turbine (3′), a compressor (7′), means of coupling the turbine (3′) and the compressor (7′), characterized in that the rotating parts of the turbine when looking in the direction (X-X′) from the compressor (7′) toward the turbine (3′) rotate in the positive trigonometric direction.

The invention notably applies to the automotive industry.

The invention applies mainly to the internal combustion engine intake turbocompressor industry.

### BACKGROUND AND SUMMARY OF THE INVENTION

The main subject of the invention is an optimized turbocompressor for engines mounted transversely, notably for in-line four-cylinder engines mounted transversely. However, the use of a turbocompressor according to the present invention with an engine, advantageously an internal combustion engine, comprising any number of cylinders and whatever the layout of these cylinders (for example in an in-line engine, a transverse engine, a V engine, a transverse V engine, a flat engine, a horizontally-opposed engine, a radial engine, a W engine, a U engine, a rotary engine or some other form of engine) of course does not depart from the scope of the present invention. For example, according to the present invention, use is made of an engine comprising between 1 and 36 cylinders, preferably between and 18 cylinders, more preferably still, between 3 and 12 cylinders, for example 3, 4, 5, 6, 8 or 12 cylinders.

At least some of the cylinders are supercharged by a turbocompressor according to the invention.

Use is made of a turbocompressor for a cylinder, preferably a turbocompressor per group of cylinders, advantageously a single turbocompressor for all of the cylinders of the engine.

The present invention applies to any type of internal combustion engine, preferably to internal combustion engines for motor vehicles, motorbikes and/or trucks.

The use of turbocompressors is described notably in the following documents:

U.S. Pat. No. 5,095,704

GB 1 603 575

U.S. Pat. No. 3,948,052

U.S. Pat. No. 5,406,795.

A turbocompressor of known type comprises a straight rigid shaft connecting a turbine which is turned by the exhaust gases of a combustion engine and a compressor that supplies an internal combustion engine with air (oxidant). The expansion of the exhaust gases drives the turbine which comprises means of mechanical joining, typically a rod arranged along the axis of rotation of the turbine, driving the rotation of the compressor. The axes of rotation of the turbine, of the rod and of the compressor, coincide. In the remainder of this patent they will be termed the axis of rotation X-X′. When looking at a turbocompressor of known type along X-X′, from the compressor toward the turbine, the rotating parts rotate in the clockwise direction (that is to say the in the opposite direction to the positive geometric direction).

The applicant company has discovered that this architecture, which will be termed a levo rotator architecture in the remainder of the patent, and as will be explained hereinafter with reference to the FIG. 2, introduces high pressure drops into an engine arranged transversely. In addition, in such instances, the paths taken by the fluid are longer and this firstly leads to a larger size and secondly requires the use of longer tubular ducts which are therefore expensive. In addition, the longer the tubular duct carrying the exhaust gases, the more these gases cool down, and this leads firstly to a reduction in turbocompressor efficiency and secondly makes the subsequent treatments aimed at removing pollution from the exhaust gases more difficult and/or less effective.

It is therefore an object of the present invention to offer a turbocompressor which is better suited to transverse engines notably to engines comprising four in-line cylinders mounted transversely.

It is another object of the present invention to offer a turbocompressor better suited to engines comprising in-line cylinders, preferably to engines comprising four in-line cylinders, and more preferably still to such engines which are mounted transversely.

It is another object of the present invention to offer a turbocompressor that exhibits good efficiency, that is to say that has optimized fluid dynamics, notably for the abovementioned engines.

It is another object of the present invention to offer a turbocompressor that occupies a small amount of space in the engine compartment.

It is another object of the present invention to offer a turbocompressor that allows connections to be made, notably to the abovementioned engines, using short tubular ducts.

The main subject of the invention is a turbocompressor comprising a turbine and coupling means and a compressor, characterized in that, when looking in the direction from the compressor toward the turbine the rotating parts of the compressor rotate in the positive trigonometric direction.

Another subject of the invention is a turbocompressor comprising a turbine, a compressor, means of coupling the turbine and the compressor, characterized in that the rotating parts of the turbine when looking in the direction from the compressor toward the turbine rotate in the positive trigonometric direction.

Another subject of the invention is a turbocompressor characterized in that the means of coupling the turbine and the compressor are straight.

Another subject of the invention is a turbocompressor characterized in that the axes of rotation of the turbine and of the compressor are aligned.

Another subject of the invention is an internal combustion engine, characterized in that it comprises a turbocompressor comprising means of connecting the compressed air outlet of the compressor to the air intake of said engine and means of connecting the combustion gases leaving the engine to the inlet of the turbine.

Another subject of the invention is an engine characterized in that it comprises straight or substantially straight means of connection joining the exhaust manifold to a lower tangential inlet of the turbine.

Another subject of the invention is an engine characterized in that it comprises straight or substantially straight means of connection joining an upper tangential compressed air outlet of the compressor to the air intake inlet of the engine.

Another subject of the invention is an engine characterized in that said engine is an in-line four-cylinder engine.

Another subject of the invention is a vehicle, characterized in that it comprises a turbocompressor and/or an engine.

Another subject of the invention is a vehicle, characterized in that it comprises an engine mounted transversely.

### BRIEF DESCRIPTION OF THE DRAWINGS

The invention will be better understood by means of the following description and of the attached figures which are given by way of nonlimiting examples and in which:

FIG. 1 is a schematic isometric view of a turbocompressor of known type;

FIG. 2 is a schematic isometric view of the compressor of known type associated with an in-line four-cylinder engine mounted transversely;

FIG. 3 is a schematic isometric view of a turbocompressor according to the present invention;

FIG. 4 is a schematic isometric view illustrating the change in architecture of the turbocompressor according to the present invention as compared with the turbocompressor tube of known type;

FIG. 5 is a schematic isometric view illustrating the combination of a turbocompressor according to the present invention with an engine comprising four in-line cylinders mounted transversely on a vehicle (not depicted).

### DETAILED DESCRIPTION

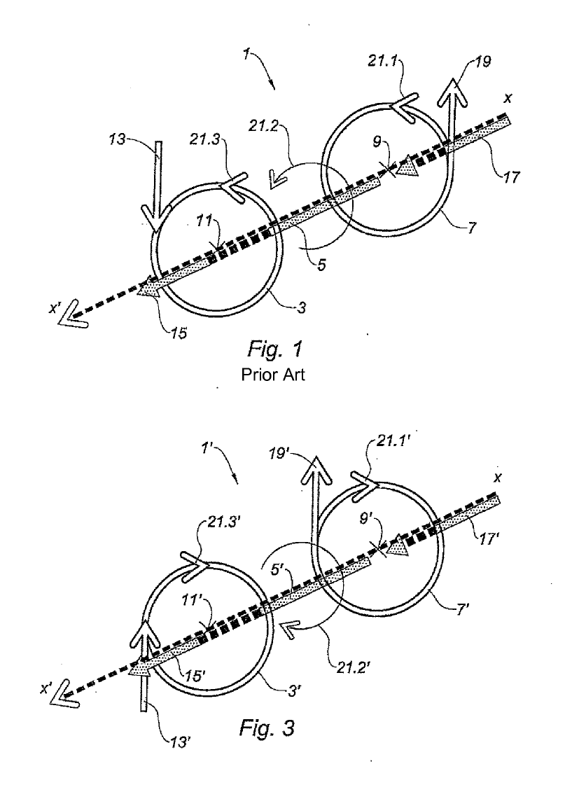

In FIGS. 1 to 5, the same references have been used to denote elements that are the same.

FIG. 1 shows a turbocompressor 1 of known type comprising a turbine 3 which, via a mechanical joining element 5, typically a shaft, drives a combustion engine air intake compressor 7.

Let X-X′ be the straight line passing at 9 through the axis of rotation of the compressor 7, the axis of revolution of the coupling means 5, and, at 11, through the axis of rotation of the turbine 3. The turbine has a tangential intake at 13 of exhaust gases which, once they have imparted some of their kinetic energy to the rotating parts of the turbine, leave the turbine 3 axially at 15 along the axis X-X′. The intake air at atmospheric pressure or substantially atmospheric pressure, enters the compressor 7 axially at 17 along the axis X-X′. The air compressed by the compressor 7 leaves tangentially at 19.

The arrow 21.1 illustrates the direction of rotation about the axis X-X′ of the rotating parts of the compressor 7. The arrow 21.2 illustrates the direction of rotation about the axis X-X′ of the coupling means 5. The arrow 21.3 illustrates the direction of rotation about the axis X-X′ of the rotating parts of the turbine 3.

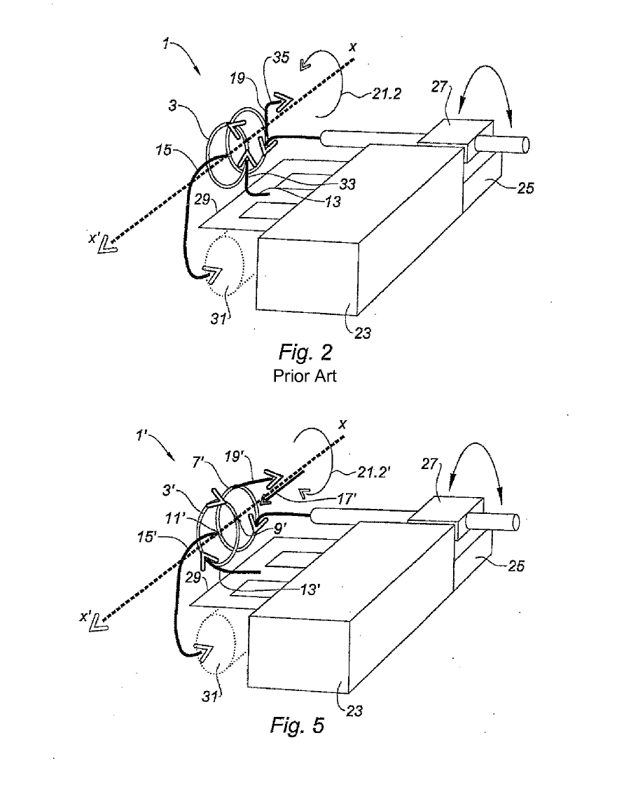

In a known way, the sets of rotating parts comprise vanes and rotate at high speed. When looking in the direction X-X′, that is to say from the compressor toward the turbine, the moving parts of the turbocompressor of known type rotate in the clockwise direction (the opposite direction to the positive trigonometric direction). However, as can be seen in FIG. 2, this arrangement is not at all optimal for supplying a transverse in-line four-cylinder engine with compressed air.

The front of the vehicle corresponds to the right-hand part of FIGS. 2 and 5.

An engine 23 is arranged transversely in the engine compartment and is extended on the left-hand part of said engine compartment by a gearbox 25.

A control 27 for the gearbox is positioned above the latter. An exhaust manifold 29 is positioned at the rear of the engine 23. Above an exhaust catalytic converter 31 known in the art as an oxi-cat. For reasons of space, the turbocompressor 1 is arranged above the exhaust manifold 29. Thus, the exhaust gas outlet 15 can be connected directly to the inlet of the catalytic converter 31. However, the intake 13 to the turbine 3, because of the direction in which it rotates, has a bend 33 which is detrimental to turbine efficiency and extends the length of the tubular duct that forms the turbine intake. Likewise, because of the direction in which the compressor 7 rotates, the compressed air outlet 19 has a bend 35 ??? toward the engine 23.

FIG. 3 shows a turbocompressor 1′ according to the present invention, advantageously fitted with the same components as the turbocompressor 1 of FIG. 1, but arranged in an optimized layout. Thus, the turbocompressor 1′ according to the present invention comprises a turbine 3′ which via a mechanical joining element 5′, typically a shaft, drives a compressor 7′ for the intake air of a combustion engine.

Let the straight line passing at 9′ through the axis of rotation of the compressor, through the axis of revolution of the coupling means 5′ and, at 11′, through the axis of rotation of the turbine 3′ be X-X′. The turbine is supplied tangentially at 13′ with the exhaust gases which leave the turbine 3′ axially at 15′, along the axis X-X′. The intake air at atmospheric pressure or substantially atmospheric pressure enters the compressor 7′ axially at 17′ along the axis X-X′. The air compressed by the compressor 7′ leaves tangentially at 19′.

The arrow 21.1′ illustrates the direction of rotation about the axis X-X′ of the moving parts of the compressor 7′. The arrow 21.2′ illustrates the direction of rotation about the axis X-X′ of the coupling means 5′. The arrow 21.3′ illustrates the direction of rotation about the axis X-X′ of the rotating parts of the turbine 3′.

The sets of rotating parts comprise vanes and rotate at high speed just like the parts of the turbocompressors of known type. When looking in the direction X-X′, that is to say from the compressor toward the turbine, the moving parts of the turbocompressor according to the invention rotate in the positive trigonometric direction (the counterclockwise direction).

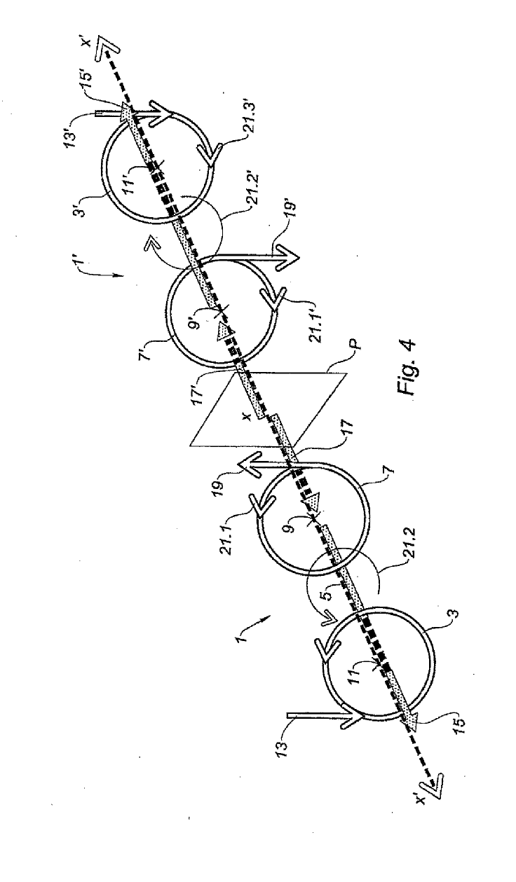

As can be seen in FIG. 4, the turbocompressors 1 and 1′ are symmetric with respect to a plane P orthogonal to the straight line X-X′. By analogy with the compressor of known type 1, which has been termed a levorotatory compressor, the compressor 1′ according to the present invention can be termed a dextrorotatory compressor. It should be noted that, just as a left hand and a right hand cannot be superposed in any orientation in space, so neither can the turbocompressors 1 and 1′.

FIG. 5 shows the extent to which the turbocompressor 1 according to the present invention is optimally adapted, notably, to suit an in-line four-cylinder engine with the cylinders arranged transversely. Specifically, given the direction of rotation and the natural layout of the turbocompressor 1′, the exhaust gas inlet 13′ can be connected directly, without a bend, to the exhaust manifold (direct connection at the bottom of the turbine 3, in the correct direction!). Likewise, the air intake 19′ situated at the top of the compressor 7′ can be connected to the air intake of the engine 23 without requiring a bend. Thus, a vehicle according to the present invention is more compact, more lightweight, less polluting and enjoys a lower fuel consumption.

Of course the present invention is not limited to the turbocompressor in which the axis of rotation of the turbine 3′, of the coupling means 5′ and of the compressor 7′ are aligned.

The compressor is driven by the turbine advantageously by mechanical joining means which are advantageously, but not necessarily, rigid, which are advantageously, but not necessarily, straight. However, pneumatic, electric, magnetic or some other form of drive do not constitute departures from the scope of the present invention.

The invention applies notably to the automotive industry.

The invention applies mainly to the internal combustion engine intake turbocompressor industry.
1,1′ turbocompressor
3,3′ turbine
5,5′ coupling means
7,7′ compressor
9,9′ compressor axis of rotation
11,11′ turbine axis of rotation
13,13′ turbine intake
15,15′ exhaust gas outlet
17,17′ air inlet
19,19′ compressed air
21.1,21.1′ compressor direction of rotation
21.2,21.2′ coupling means direction of rotation
21.3,21.3′ turbine direction of rotation
23 engine
25 gearbox
27 gearbox control
29 exhaust manifold
31 oxi-cat
33 exhaust gas inlet bend
35 compressed air bend

1. A turbocompressor (1′) comprising a turbine (3′), a compressor (7′) and means of coupling the turbine and the compressor, characterized in that, when looking in a direction (X-X′) from the compressor (7′) toward the turbine (3′) rotating parts of the compressor rotate in the positive trigonometric direction.

2. A turbocompressor (1′) comprising a turbine (3′), a compressor (7′), and means of coupling the turbine (3′) and the compressor (7′), characterized in that rotating parts of the turbine when looking in a direction (X-X′) from the compressor (7′) toward the turbine (3′) rotate in the positive trigonometric direction.

3. The turbocompressor as claimed in claim 1, characterized in that the means of coupling the turbine (3′) and the compressor (7′) are straight.

4. The turbocompressor as claimed in claim 1, characterized in that axes of rotation of the turbine (3′) and of the compressor (7′) are aligned.

5. An internal combustion engine, characterized in that the engine comprises a turbocompressor (1′) as claimed in claim 1, means of connecting a compressed air outlet of the compressor (7′) to an air intake of said engine and means (29′) of connecting combustion gases leaving the engine to an inlet (13′) of the turbine (3′).

6. The engine as claimed in claim 5, characterized in that the engine comprises straight or substantially straight means of connection joining an exhaust manifold (29′) to a lower tangential inlet (13′) of the turbine (3′).

7. The engine as claimed in claim 5, characterized in that the engine comprises straight or substantially straight means of connection joining an upper tangential compressed air outlet (19′) of the compressor to the air intake inlet of the engine (23).

8. The engine as claimed in claim 5, characterized in that said engine (23) is an in-line four-cylinder engine.

9. A vehicle, characterized in that the vehicle comprises a turbocompressor as claimed in claim 1.

10. The vehicle as claimed in claim 9, characterized in that the vehicle comprises an engine mounted transversely, the engine comprising means of connecting a compressed air outlet of the compressor (7′) to an air intake of said engine and means (29′) of connecting combustion gases leaving the engine to an inlet (13′) of the turbine (3′).

11. A vehicle, characterized in that the vehicle comprises an engine as claimed in claim 5.

12. The turbocompressor as claimed in claim 2, characterized in that the means of coupling the turbine (3′) and the compressor (7′) are straight.

13. The turbocompressor as claimed in claim 12, characterized in that axes of rotation of the turbine (3′) and of the compressor (7′) are aligned.

14. An internal combustion engine, characterized in that the engine comprises a turbocompressor (1′) as claimed in claim 13, means of connecting a compressed air outlet of the compressor (7′) to an air intake of said engine and means (29′) of connecting combustion gases leaving the engine to an inlet (13′) of the turbine (3′).

15. The turbocompressor as claimed in claim 3, characterized in that axes of rotation of the turbine (3′) and of the compressor (7′) are aligned.

16. An internal combustion engine, characterized in that the engine comprises a turbocompressor (1′) as claimed in claim 15, means of connecting a compressed air outlet of the compressor (7′) to an air intake of said engine and means (29′) of connecting combustion gases leaving the engine to an inlet (13′) of the turbine (3′).

17. The engine as claimed in claim 14, characterized in that the engine comprises straight or substantially straight means of connection joining an exhaust manifold (29′) to a lower tangential inlet (13′) of the turbine (3′).

18. The engine as claimed in claim 16, characterized in that the engine comprises straight or substantially straight means of connection joining an exhaust manifold (29′) to a lower tangential inlet (13′) of the turbine (3′).
